(19) United States
(12) Patent Application Publication
(10) Pub. No.: US 2025/0336660 A1
(43) Pub. Date: Oct. 30, 2025

(54) HALOGEN ELEMENT DETERMINATION METHOD AND HALOGEN ELEMENT DETERMINATION DEVICE

(71) Applicant: INSTITUTE OF GEOLOGY AND GEOPHYSICS, CHINESE ACADEMY OF SCIENCES, BEIJING (CN)

(72) Inventors: YINZHI WANG, BEIJING (CN); LIEKUN YANG, BEIJING (CN); WENBEI SHI, BEIJING (CN); FEI WANG, BEIJING (CN)

(21) Appl. No.: 18/883,069

(22) Filed: Sep. 12, 2024

(30) Foreign Application Priority Data
Apr. 30, 2024 (CN) 202410537065.3

(51) Int. Cl. H01J 49/04; H01J 49/00; H01J 49/24

(52) U.S. Cl. CPC H01J 49/0468; H01J 49/0009; H01J 49/0422; H01J 49/24

(57) ABSTRACT

A halogen element determination method and a halogen element determination device are provided, belonging to the technical field of geological sample detection. The method includes the following steps: converting halogens in a sample into noble gases by irradiation; heating the sample using a laser device to extract target gases; adsorbing active gases in the target gases to purify the target gases; enriching and separating purified noble gases according to different condensation temperatures, and enabling the noble gases after enrichment and separation to enter a noble gas mass spectrometer in turn for testing; and calculating a yield of converting halogens into the noble gases after irradiation through a standard sample, and inferring the content of halogen elements through the volume of noble gases in an unknown sample by calculating the volume of noble gases produced by a standard sample with known content of halogen elements.

### CROSS-REFERENCE TO RELATED APPLICATION

This patent application claims the benefit and priority of Chinese Patent Application No. 202410537065.3 filed with the China National Intellectual Property Administration on Apr. 30, 2024, the disclosure of which is incorporated by reference herein in its entirety as part of the present application.

### TECHNICAL FIELD

The present disclosure relates to the technical field of geological sample detection, and in particular to a halogen element determination method, and a halogen element determination device.

### BACKGROUND

The content and ratio of halogen elements (halogens for short, such as F, Cl, Br and I) in melts, fluids, minerals and chemicals can provide important information for chemical prospecting, geological process tracing, environmental monitoring and protection, chemical production and other aspects for promoting national economic development.

At present, the commonly used halogen analysis methods for geological samples include ion chromatography, X-ray fluorescence analysis, an electron probe method, inductively coupled plasma mass spectrometry and so on. There are still great difficulties in accurately determination of the content of halogens, especially heavy halogens (Br and I) in geological samples by the above methods, which are mainly manifested in the following aspects: First, based on the characteristics of halogens themselves, the halogen is highly incompatible and has low content in crustal and mantle rocks, and the content of Br and I are much lower than 1 μg/g; the halogen has strong volatility, which is volatile or easy to be adsorbed on the inner wall of the instrument to cause obvious memory effect, and volatile loss of samples often occur when the samples are digested; the halogen has high ionization energy, and thus is low in ionization efficiency when tested by using the inductively coupled plasma mass spectrometry, making it difficult to accurately determine low-content samples. Second, there are problems in testing instruments or processes. Large amounts of halogen-containing acids are used in sample pretreatment, resulting in high background, incomplete halogen extraction and unstable recovery rate. The existing factors such as the matrix effect, fractionation and various interference peaks in conventional methods hinder the accurate determination of (ultra-) low-content halogen.

There are complex and dangerous sample pretreatment processes in the above methods and processes. For example, high-temperature heating (900-1200° C.) or acid-base reagents needs to be used in high-temperature pyrolysis method, alkaline fusion method and acid digestion method used in the process of digesting solid samples to digest, recover and retest the solid samples. Various reagents and containers will be used in the operation, which is cumbersome and time-consuming, and not conducive to processing a large number of samples. Moreover, frequent use of high-temperature equipment and acid-base reagents will increase the safety risk for operators. In addition, the most fatal problem in the existing methods is that inaccurate analysis result and poor data quality are easily caused due to the characteristics of halogen with low content, volatile, and difficult ionization.

Therefore, the existing method cannot meet the requirements of micro-halogen analysis in geological samples.

### SUMMARY

An objective of the present disclosure is to provide a halogen element determination device and a halogen element determination method to solve the problems in the prior art. Halogens in samples are converted into noble gases by irradiation for testing, such that the accurate determination of low-content and ultra-low-content halogen can be achieved to provide new equipment and new technology for halogen research urgently needed in geological research, environmental detection, chemical engineering, and other fields, especially for the analysis and testing of samples with low and ultra-low halogen content.

To achieve the objective above, the following technical solutions are provided in the present disclosure:

A halogen element determination method is provided in the present disclosure, including the following steps:
converting halogens in a sample into noble gases by irradiation;
heating a surface of the sample by using a laser device to extract target gases;
adsorbing active gases in the target gases to purify the target gases;
enriching and separating purified noble gases according to different condensation temperatures, and enabling the noble gases after enrichment and separation to enter a noble gas mass spectrometer in turn for testing; and
calculating a yield of converting halogens into noble gases after irradiation by a standard sample, and inferring a content of halogen elements through a volume of noble gases in an unknown sample by calculating a volume of noble gases produced by a standard sample with known content of halogen elements.

Preferably, when the sample is heated, the surface of the sample is first heated at low energy to remove attached air, and then the energy is increased until the sample is completely melted, thus completely extracting the target gases.

Preferably, before purifying the target gases, the target gases are completely enriched by low-temperature grabbing of a cold trap I, thus improving a utilization rate of the target gases, and improving signal strength of the testing.

Preferably, when the target gases are purified, active gases are adsorbed and removed by a suction pump.

Preferably, before heating the sample, a treatment system is vacuumized, the sample is placed in an extraction system, and the extraction system is vacuumized. Vacuum extractions of the extraction system and the treatment system are independent to each other and do not affect each other. The extraction system is communicated with the treatment system; and the extraction system, the treatment system and the noble gas mass spectrometer are vacuumized to a set state.

A halogen element determination device is provided in the present disclosure, where the halogen element determination method above is applied, and the halogen element determination device includes an extraction system, a treatment system, a vacuum system, and an analysis system. The extraction system includes a laser device, and a sample tray. The laser device is configured to heat a sample placed on the sample tray to extract target gases. The treatment system includes a suction pump, and a cold trap II. The suction pump is configured to adsorb active gases in the target gases, and the cold trap II is configured to enrich and separate purified gases Ar, Kr and Xe according to different condensation temperatures and to enable the gases Ar, Kr and Xe after enrichment and separation to enter the analysis system in turn. The analysis system employs a noble gas mass spectrometer. The vacuum system is configured to vacuumize the extraction system, the treatment system, and the analysis system.

Preferably, the vacuum system includes a vacuum system I, and a vacuum system II. The vacuum system I is connected to the extraction system, and the vacuum system II is connected to the treatment system.

Preferably, the halogen element determination device further includes a vacuum gauge I, a vacuum gauge II, and a vacuum gauge III. The vacuum gauge I is connected to the treatment system, the vacuum gauge II is connected to the vacuum system II, and the vacuum gauge III is connected to the vacuum system I.

Preferably, the halogen element determination device further includes a calibration system. The calibration system is simultaneously connected to the extraction system and the treatment system, and the calibration system includes a standard air tank and a small-volume dispensing tube.

Preferably, the suction pump includes a titanium sublimation pump, a GP50 suction pump and a NP10 suction pump. Different suction pumps are connected to a main pipeline of the treatment system by different valves.

Compared with the prior art, the present disclosure has the following technical effects:

According to the present disclosure, halogens in a sample are converted into noble gases by irradiation for testing, which has the following advantages: (1) there is no need for halogen to make a complicated chemical extraction, thus avoiding the problems of incomplete extraction, unstable recovery efficiency and the like in the traditional method. (2) The characteristics of volatile and difficult ionization of halogens need not be considered in the test of converting the halogens into noble gases. (3) The interference of matrix effect can be avoided only by testing the purified target gases. (4) The noble gas mass spectrometer has the characteristics of high precision and high sensitivity, and the detection limit is low. Therefore, the noble gas method adopted in the present disclosure can achieve the accurate determination of low-content and ultra-low-content halogen. Through the comprehensive research of hardware configuration and experimental flow, a perfect analysis method for halogen determination of noble gases is established, which can provide new equipment and new technology for halogen research urgently needed in geological research, environmental detection, chemical engineering, and other fields, especially for the analysis and testing of samples with low and ultra-low halogen content.

### BRIEF DESCRIPTION OF THE DRAWINGS

To describe the technical solutions of the embodiments of the present disclosure or in the prior art more clearly, the following briefly introduces the accompanying drawings required and used in the embodiments. Apparently, the accompanying drawings in the following description show merely some embodiments of the present disclosure, and those skilled in the art may still derive other drawings in accordance with these accompanying drawings without creative efforts.

FIG. 1 is a schematic view of main components of a halogen element determination device according to the present disclosure;

FIG. 2 is a schematic view of an entirety of a halogen element determination device according to the present disclosure.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. Based on the embodiments of the present disclosure, all other embodiments obtained by those skilled in the art without creative efforts shall fall within the protection scope of the present disclosure.

An objective of the present disclosure is to provide a halogen element determination method and a halogen element determination device to solve the problems in the prior art. Halogens in samples are converted into noble gases by irradiation for testing, such that the accurate determination of low-content and ultra-low-content halogen can be achieved to provide new equipment and new technology for halogen research urgently needed in geological research, environmental detection, chemical engineering, and other fields, especially for the analysis and testing of samples with low and ultra-low halogen content.

In order to make the objectives, features and advantages of the present disclosure more clearly, the present disclosure is further described in detail below in combination with the accompanying drawings and the embodiments.

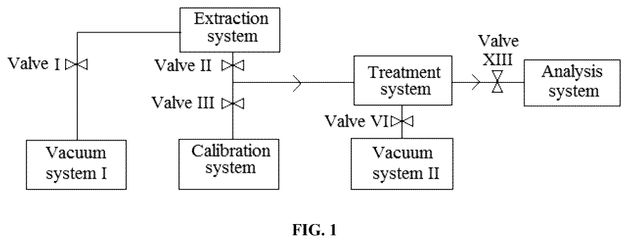

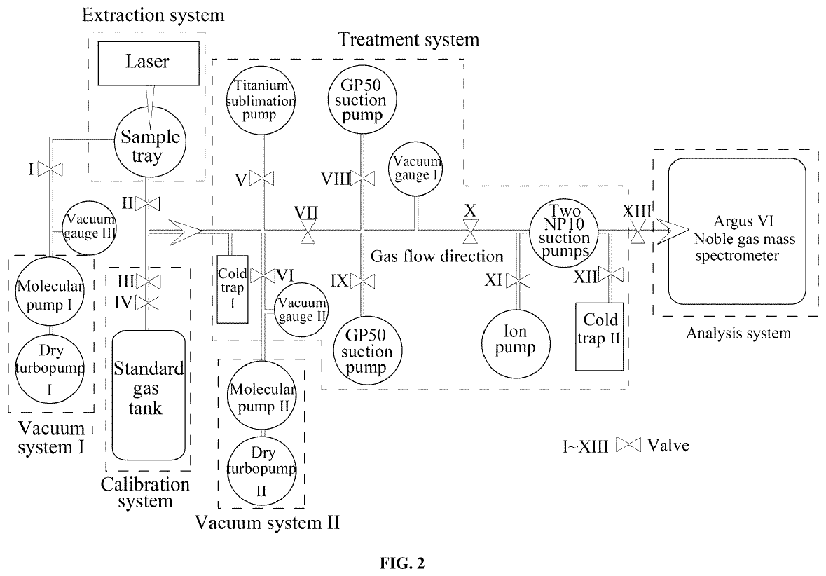

As shown in FIG. 1 and FIG. 2, a halogen element determination method is provided in the present disclosure, including the following steps:

Sample preparation, the samples herein include melts, fluids, minerals, and chemicals, especially samples with low and ultra-low halogen content.

Halogens in the sample are converted into noble gases by irradiation, that is, Cl, Br and I in the sample are converted into noble gases ³⁸Ar_{Cl}, ⁸⁰Kr_{Br} and ¹²⁸Xe_{I} by irradiation, where ³⁸Ar_{Cl}, ⁸⁰Kr_{Br} and ¹²⁸Xe_{I} refer to the noble gases transformed from Cl, Br and I, respectively. Cl is irradiated to produce noble gas ³⁸Ar, Br is irradiated to produce noble gas ⁸⁰Kr, and I is irradiated to produce noble gas ¹²⁸Xe. The above noble gases do not exist in the sample originally, and are new products after thermal neutron irradiation, and the testing of noble gases can be converted into the testing of halogen content. It needs to be noted that the reaction principle of converting the halogens into noble gases by irradiation is an existing theory, and the present disclosure only applies this theory to the testing of halogen in the sample. In addition, as the irradiation duration and irradiation flux will affect the yield of noble gas, the irradiation duration and irradiation flux need to be regulated according to different samples, which can be operated using technical means in this art according to the theory put forward by the present disclosure. Therefore, different yields or improvements on yields applied in specific embodiments belong to the protection scope of the present disclosure.

A surface of the sample is heated by using a laser device to release noble gases from the sample, thus achieving the extraction of target gases.

Active gases in the target gases are adsorbed by technical means known in the art, for example, the target gases are purified by chemical adsorption or physical adsorption, and the adsorbed active gases include hydrogen, oxygen, nitrogen, and carbon monoxide.

The purified noble gases are enriched and separated according to different condensation temperatures, and then enter a noble gas mass spectrometer in turn for testing. The purified gases Ar, Kr and Xe have different condensation temperatures, among which, the condensation temperature of Ar is −186° C., the condensation temperature of Kr is −157° C., and the condensation temperature of Xe is −108° C. When the temperature is reduced to −186° C., all the noble gases are condensed. After the temperature rises gradually, Ar is released first, Kr is subsequently released, and Xe is finally released, and thus the different noble gases are sequentially entered into the noble gas mass spectrometer according to different condensation temperatures for testing.

During testing, a standard sample is required to monitor the reliability of the flow process, and calculate a neutron flux, and a conversion rate between halogen elements and noble gases. A yield of converting halogens into noble gases after irradiation is calculated through a standard sample, and the content of halogen elements is inferred through the volume of noble gases in an unknown sample by calculating the volume of noble gases produced by a standard sample with known content of halogen elements. The ⁴⁰Ar/³⁹Ar-age standard samples, such as hornblende Hb3Gr and biotite GA1550, and standard samples with known halogen element content can be used to calculate the neutron flux and the conversion rate between halogens and noble gases. The following solutions can be adopted in the specific operation: samples are broken into between 40 to 60 meshes, the samples with a weight between 10 to 20 mg are taken, and the weighted samples are wrapped with aluminum foil into circular sheets with a diameter of about 0.5 cm and a thickness of 0.2 cm; the wrapped samples are placed in quartz tubes with a diameter of 0.6 cm and a length of 3.0 cm, and one standard sample is placed after every three to five amount of unknown samples are placed; and the multiple quartz tubes are encapsulated into a vacuum quartz tank. The samples at different positions in the quartz tank may experience slightly different neutron fluxes after long-term neutron irradiation. The change of the neutron flux can be monitored through the interval placement of multiple standard samples Hb3Gr or GA1550.

In the present disclosure, halogens in samples are converted into noble gases by irradiation for testing, which has the following advantages: (1) there is no need for halogen to make a complicated chemical extraction, thus avoiding the problems of incomplete extraction, unstable recovery efficiency and the like in the traditional method. (2) The characteristics of volatile and difficult ionization of halogens need not be considered in the test of converting the halogens into noble gases. (3) The interference of matrix effect can be avoided only by testing the purified target gases. (4) The noble gas mass spectrometer has the characteristics of high precision and high sensitivity, and the detection limit is low, such that the content of the Cl, Br and I at a nanogram/gram level can be accurately tested, and the determination of ultra-low-content halogen can be achieved. Therefore, the noble gas method adopted in the present disclosure can achieve the accurate determination of low-content and ultra-low-content halogen. Through the comprehensive research of hardware configuration and experimental flow, a perfect analysis method for halogen determination of noble gases is established, which can provide new equipment and new technology for halogen research urgently needed in geological research, environmental detection, chemical engineering, and other fields, especially for the analysis and testing of samples with low and ultra-low halogen content.

In a further solution, when the sample is heated, the surface of the sample may be first heated with low energy to remove attached air, then the energy is increased until the sample is completely melted, thus completely extracting the target gases. The laser device can be used in the process of heating, and the laser device is set in about 0.8 watts when low energy is needed and the laser device is set in about 10 watts when high energy is needed, and thus the target gases Ar, Kr and Xe can be successfully extracted completely. The energy required for completely melting of different samples may be different, which can be adjusted according to the actual situation.

Due to low halogen content in the sample, the volume of noble gases converted after irradiation is also relatively low. Before purifying the target gases, the target gases are completely enriched by low-temperature grabbing of a cold trap I, then the enriched gases are correspondingly purified and tested, and thus the utilization rate of the gases and signal strength of testing can be improved.

Specifically, when the target gases are purified, the active gases can be adsorbed and removed by a suction pump. The active gases can be removed by the suction pump with different functions and working efficiency, without affecting the noble gases. The active gases are adsorbed and removed by the suction pump, and the remaining noble gases are tested.

In order to avoid the interference and influence of air in the system, a vacuumizing operation is required before heating the sample. During vacuumizing operation, the treatment system is firstly vacuumized. An extraction system is vacuumized after the sample is placed in the extraction system. Vacuum extractions of the extraction system and the treatment system are independent to each other and do not affect each other. The extraction system is communicated with the treatment system. The extraction system, the treatment system and the noble gas mass spectrometer (summarized as analysis system) are vacuumized to reach a state with a set vacuum degree.

Referring to FIG. 1 and FIG. 2 again, a halogen element determination device is provided in the present disclosure, which can be used by applying the halogen element determination method described above. The halogen element determination device includes an extraction system, a treatment system, a vacuum system and an analysis system. The extraction system includes a laser device, and a sample tray. The laser device is used to heat a sample placed on the sample tray to extract target gases. The treatment system includes a suction pump and a cold trap II, which can achieve the functions of purification, separation, and enrichment of the gases. The suction pump is used to adsorb active gases in the target gases, and the cold trap II is used to enrich and separate purified gases Ar, Kr and Xe according to their different condensation temperatures and to enable the gases after enrichment and separation to enter the analysis system in turn. The analysis system employs a noble gas mass spectrometer (e.g., an Argus VI noble gas mass spectrometer. Thermo Scientific Argus VI high-resolution magnetic mass spectrometry is used in a testing system provided by the present disclosure. One of important features of the Argus VI instrument is that the Argus VI instrument has small internal volume (700 cc), and the concentration is higher for the same gas volume. A receiver group includes five Faraday detectors, which can achieve simultaneous reception of different mass numbers. A Faraday cup control system includes a new high-gain amplifying circuit, which improves the dynamic measurement range of the signal, and thus has obvious advantages for the determination of Kr and Xe with small signal amount), and the noble gas mass spectrometer is connected to the treatment system. The vacuum system is used to vacuumize the extraction system, the treatment system and the analysis system, so as to reach an expected vacuum state. During actual testing, the system needs to reach an ultra-vacuum state 10-10 mbar before testing.

The treatment system further includes a cold trap I which is located at a front end of the treatment system. First, the cold trap I is used to grab and enrich the extracted gases to enhance the concentration of the gases, and then to release the gases for purification. The cold trap II is located at a front end of the noble gas mass spectrometer, the purified gases are enriched again by the cold trap II, and then enter the noble gas mass spectrometer after being released and separated according to different condensation temperatures. A valve X is arranged at a front end of the cold trap II, such that most gases can be grabbed by the cold trap II. After the valve X is closed, the noble gases Ar, Kr and Xe are separated according to their different condensation temperatures, and the separated noble gases are respectively entered into the noble gas mass spectrometer for testing. By adopting the above testing flow process, on one hand, the signal strength can be enhanced, and on the other hand, the interference between different gases can be avoided, thus improving the accuracy of testing data.

The vacuum system includes a vacuum system I and a vacuum system II. The vacuum system I is connected to the extraction system by a valve I, and the vacuum system II is connected to the treatment system by a valve VI. Therefore, the extraction system, the treatment system and the analysis system may be communicated with one another, and may be independent of each other. All the three systems are provided with independent vacuum systems, which do not affect each other and can prevent to be polluted. The vacuum system I and the vacuum system II may have the same configuration, i.e., including a molecular pump and a dry turbopump arranged at a front stage of the molecular pump. The vacuum of the extraction system is achieved through the vacuum system I, and the vacuum of the treatment system is achieved through the vacuum system II. As the sample tray at the extraction system needs to be exposed to the atmosphere during sample replacement, in order to ensure the vacuum degree of the treatment system part, a valve II is arranged between the extraction system and the treatment system for isolating them. After the sample tray is opened and the sample is replaced, a valve I is opened, and the vacuum degree of the extraction system is achieved by the dry turbopump I and the molecular pump I of the vacuum system I, which can be up to 10⁻⁹ mbar. In addition, the treatment system may also be connected to an ion pump by a valve XI. When a higher vacuum degree is needed, the ion pump can be used to further improve the vacuum degree.

The halogen element determination device further includes a vacuum gauge I, a vacuum gauge II and a vacuum gauge III. The vacuum gauge I is connected to the treatment system, the vacuum gauge II is connected to the vacuum system II, and the vacuum gauge III is connected to the vacuum system I. The vacuum degrees of the treatment system, the vacuum system II and the vacuum system I are monitored by the vacuum gauge I, the vacuum gauge II and the vacuum gauge III, respectively. For the extraction system, that is, a testing area of the vacuum gauge III, the required vacuum degree is low, about 10⁻⁷ mbar, and the highest vacuum degree of the vacuum gauge II is about 10⁻⁹ mbar. The vacuum degree measured by the vacuum gauge I and required by the treatment system is the highest, and the measurable vacuum degree of the vacuum gauge I may be about 10⁻¹⁰ mbar.

The halogen element determination device further includes a calibration system. The calibration system is simultaneously connected to the extraction system and the treatment system, and includes a standard air tank with the known volume and pressure and a small-volume dispensing tube (the volume of the dispensing tube may be 0.1 cc). The gas in the standard air tank is diffused into the small-volume dispensing tube, and the gas pressure in the small-volume dispensing tube is calculated by Boyle's law. The sensitivity of mass spectrometry can be obtained by diffusing the standard gas with the known volume and pressure into mass spectrometry. Moreover, the quality discrimination of the instrument can be obtained by the difference between measured values of Ar, Kr and Xe in the standard gas and the corresponding theoretical values, thus correcting the measured values of the sample.

The suction pump may include a titanium sublimation pump, a GP50 suction pump and a NP10 suction pump, and different suction pumps are connected to main pipelines of the treatment system by different valves. The titanium sublimation pump is connected to the main pipeline by a valve V, and the GP50 suction pumps are respectively connected to the main pipeline by a valve VIII and a valve IX. Through the control of the valve V, the valve VIII, and the valve IX, whether the above-mentioned pump bodies are added into the purification flow process can be freely selected according to different samples. Active titanium is used as a getter material of the titanium sublimation pump, and the hydrogen, oxygen, nitrogen and carbon monoxide are adsorbed by chemical adsorption. In specific application, GP50 suction pumps and NP10 suction pumps may be chosen form the products of SEAS Company. The two GP50 suction pumps work at a normal temperature and a high temperature, respectively, and the working states of the two NP10 suction pumps are the same as those of the GP50 suction pumps. The difference between the GP50 suction pump and the NP10 suction pump is that the GP50 suction pump has stronger adsorption capacity, and can be used for the sample with the large volume of released gas and more complex components. The NP10 suction pump is used for routine use, the two NP10 suction pumps are arranged in a cavity, and one of the NP10 suction pump is located above and the other one of the NP10 suction pump is located below, and the two NP10 suction pumps are not in contact with each other. The reason for providing the two NP10 suction pumps is that the two NP10 suction pumps are different in working temperatures and functions. The working temperature of one suction pump is set to a normal temperature, which is mainly used to remove H₂ from the gas; and the working temperature of the other suction pump is set as 400° C., which is mainly used to remove other active gases such as N₂, O₂, and CO₂.

In conjunction with FIG. 1 and FIG. 2, by adopting the halogen element determination device and the halogen element determination method, the sample testing flow process of the present disclosure is as follows:

### 1. Guarantee of Ultra-High Vacuum State of System

A valve XI is closed, all valves of the treatment system are opened, and the dry turbopump II and the molecular pump II of the vacuum system II are used for air extraction. After the vacuum degree reaches 10⁻⁸ to 10⁻⁹ mbar, the valve VI is closed, the valve XI is opened, and an ion pump is connected to reduce the vacuum degree to 10⁻¹⁰ mbar. The vacuum gauge I and the vacuum gauge II are used for monitoring in real time.

The valve I and the valve II are closed, the sample tray is opened to place a sample to be tested, the sample tray is sealed, the valve I is opened, and the air in the sample tray is pumped out by the vacuum system I (dry turbopump I+molecular pump I). After monitoring by the vacuum gauge III that the vacuum degree of the sample tray reaches 10⁻⁷ to 10⁻⁸ mbar, the valve II is opened, the sample tray is connected into the treatment system, and pumped by the ion pump to reach high-level vacuum degree. The noble gas mass spectrometer is always at the ultra-high vacuum degree 10⁻¹⁰ mbar through the ion pump.

### 2. Extraction and Treatment Process of Gas

First, the surface of the sample is heated with a laser device at low energy (about 0.8 W) to remove the attached air, and then the energy is increased (to about 10 W) until the sample is completely molten to completely extract the target gases Ar, Kr, and Xe. The energy required for full melting of different samples is different. The extracted gases, including noble gases and active gases (hydrocarbons, N₂, O₂, H₂, CO₂, etc.), enter the treatment system after the valve II is opened. The gases entering the treatment system are first enriched through low-temperature grabbing of the cold trap I, and then the valve II is closed to improve the utilization rate of gases and the signal strength of the testing. The active gases are adsorbed and removed by the suction pump, and the remaining noble gases are tested. Conventional suction pumps used in purification are two NP10 suction pumps, and in order to achieve the optimal purification effect in the actual testing, different suction pumps can be selected and added by opening and closing valves V, VIII and IX according to the sample situation. The valve XII is opened, and the purified gases Ar, Kr and Xe (the condensation temperature of Ar is −186° C., the condensation temperature of Kr is −157° C., and the condensation temperature of Xe is −108° C.) are enriched and separated by the cold trap II according to different condensation temperatures, and then enter the noble gas mass spectrometer in turn for testing.

### 3. Testing and Data Processing

The mass numbers of the three noble gases Ar, Kr and Xe are different, so it is necessary to adjust testing parameters of an electric field and a magnetic field during testing. Under normal circumstances, Ar is of large gas volume and strong signal, and is tested by the Faraday cup. Kr and Xe are of small gas volume and weak signal, and are tested by using an electron multiplier to improve the accuracy. In an irradiation stage, the magnitude of thermal neutron flux and the conversion rate between the halogen elements and the noble gases are monitored and calculated by standard samples. After the testing of each of the samples is completed, the valve II and the valve VI are opened for air extraction, the valve VI is closed after 15 minutes, and the valve XI is opened to achieve higher vacuum degree by using the ion pump. The remaining gases in the system are pumped to prepare for the testing of the next sample.

During testing and data processing, the following aspects need to be noted:

1. Selection of optimal testing conditions. After neutron irradiation, Cl, Br and I in the sample are converted into noble gases Ar, Kr and Xe. The content of Cl, Br and I in the geological sample is low, so the volume of noble gases converted from Cl, Br and I is relatively small. The requirements of quality discrimination for system blank and the rare gas mass spectrometer are strict in low gas volume analysis. A low and relatively stable blank level can be obtained by means of bakeout outgassing and testing flow optimizing. The number of standard air tests on the same day is increased, and the standard air with different volumes is tested and compared to obtain a more stable quality discrimination correction factor. As the three noble gases have different releases in the extraction process, the instrument shows different sensitivity in the testing process. Therefore, during testing, the heating temperature, laser ablation beam spot size, laser frequency and erosion time in multiple testing stages are required, such that the background is reduced, and a signal-to-noise ratio is improved. A state of an ion source is debugged to obtain the optimal sensitivity and achieve accurate determination. For small gas-volume signals such as Kr and Xe, the purified gases can be enriched with the cold trap II before analysis, and then Ar, Kr and Xe can be respectively released and separately tested, which not only can enhance the signal strength, but also can overcome the memory effect of the noble gas mass spectrometer produced on ¹²⁸Xe and ¹³¹Xe due to the existence of ⁴⁰Ar+ current in the testing process.

2. Data processing. An obtained gas signal is converted into the required halogen content. The data processing includes calculating the yield of the noble gas, correcting quality discrimination, and deducting background, atmospheric value, interfering nuclides, etc. The measurement of the background can be obtained by testing the gas volume in the whole system before testing the sample on the same day, at different sample testing intervals and after testing on the same day, thus monitoring the changes of the background before, during and after testing. The deduction of the atmospheric value is calculated and deducted by detecting the value of non-to-be-detected isotopes in standard air and obtaining the atmospheric value of an element to be detected according to the stable isotope ratio. The quality discrimination effect is also obtained by testing the standard air on the same day of the experiment. The interfering nuclides that may be produced during irradiation mainly include ³⁶Ar_{Cl}, ³⁸Ar_{K}, ⁸⁴Kr_{U} and ¹³²Xe_{U}, which can be deducted by a standard gas value, potassium salt and a specific ratio between isotopes from a single source. The yield of converting the halogens into noble gases after irradiation is calculated through the standard sample. The content of halogen elements can be inferred through the volume of noble gases in an unknown sample by calculating the volume of noble gases produced by a standard sample with known content of halogen elements.

Specific examples are used herein for illustration of the principles and embodiments of the present disclosure. The description of the above embodiments is merely used to help illustrate the method and its core ideas of the present disclosure. Meanwhile, those skilled in the art can make various modifications in terms of specific embodiments and application scope in accordance with the ideas of the present disclosure. In conclusion, the content of this specification shall not be construed as a limitation to the present disclosure.

What is claimed is:

1. A halogen element determination method, comprising the following steps:
converting halogens in a sample into noble gases by irradiation;
heating a surface of the sample by using a laser device to extract target gases;
adsorbing active gases in the target gases to purify the target gases;
enriching and separating purified noble gases according to different condensation temperatures, and enabling the noble gases after enrichment and separation to enter a noble gas mass spectrometer in turn for testing; and
calculating a yield of converting halogens into noble gases after irradiation through a standard sample, and inferring a content of halogen elements through a volume of noble gases in an unknown sample by calculating a volume of noble gases produced by a standard sample with known content of halogen elements.

2. The halogen element determination method according to claim 1, wherein when the sample is heated, the surface of the sample is first heated at low energy to remove attached air, and then the energy is increased until the sample is completely melted, thus completely extracting the target gases.

3. The halogen element determination method according to claim 1, wherein before purifying the target gases, the target gases are completely enriched by low-temperature grabbing of a cold trap I, thus improving a utilization rate of the target gases and improving signal strength of the testing.

4. The halogen element determination method according to claim 1, wherein when the target gases are purified, active gases are adsorbed and removed by a suction pump.

5. The halogen element determination method according to claim 1, wherein before heating the sample, a treatment system is vacuumized, the sample is placed in an extraction system, and the extraction system is vacuumized; vacuum extractions of the extraction system and the treatment system are independent to each other and do not affect each other; the extraction system is communicated with the treatment system; and the extraction system, the treatment system and the noble gas mass spectrometer are vacuumized to a set state.

6. A halogen element determination device, wherein the halogen element determination method according to claim 1 is applied, comprising an extraction system, a treatment system, a vacuum system, and an analysis system; the extraction system comprises a laser device and a sample tray; the laser device is configured to heat a sample placed on the sample tray to extract target gases; the treatment system comprises a suction pump and a cold trap II, the suction pump is configured to adsorb active gases in the target gases, and the cold trap II is configured to enrich and separate purified gases Ar, Kr and Xe according to different condensation temperatures and to enable the gases Ar, Kr and Xe after enrichment and separation to enter the analysis system in turn; the analysis system employs a noble gas mass spectrometer; and the vacuum system is configured to vacuumize the extraction system, the treatment system and the analysis system.

7. The halogen element determination device according to claim 6, wherein the vacuum system comprises a vacuum system I, and a vacuum system II; and the vacuum system I is connected to the extraction system, and the vacuum system II is connected to the treatment system.

8. The halogen element determination device according to claim 7, further comprising a vacuum gauge I, a vacuum gauge II and a vacuum gauge III, wherein the vacuum gauge I is connected to the treatment system, the vacuum gauge II is connected to the vacuum system II, and the vacuum gauge III is connected to the vacuum system I.

9. The halogen element determination device according to claim 6, further comprising a calibration system, wherein the calibration system is simultaneously connected to the extraction system and the treatment system, and the calibration system comprises a standard air tank and a small-volume dispensing tube.

10. The halogen element determination device according to claim 6, wherein the suction pump comprises a titanium sublimation pump, a GP50 suction pump and a NP10 suction pump, and different suction pumps are connected to a main pipeline of the treatment system by different valves.

11. A halogen element determination device, wherein the halogen element determination method according to claim 2 is applied, comprising an extraction system, a treatment system, a vacuum system, and an analysis system; the extraction system comprises a laser device and a sample tray; the laser device is configured to heat a sample placed on the sample tray to extract target gases; the treatment system comprises a suction pump and a cold trap II, the suction pump is configured to adsorb active gases in the target gases, and the cold trap II is configured to enrich and separate purified gases Ar, Kr and Xe according to different condensation temperatures and to enable the gases Ar, Kr and Xe after enrichment and separation to enter the analysis system in turn; the analysis system employs a noble gas mass spectrometer; and the vacuum system is configured to vacuumize the extraction system, the treatment system and the analysis system.

12. The halogen element determination device according to claim 11, wherein the vacuum system comprises a vacuum system I, and a vacuum system II; and the vacuum system I is connected to the extraction system, and the vacuum system II is connected to the treatment system.

13. The halogen element determination device according to claim 12, further comprising a vacuum gauge I, a vacuum gauge II and a vacuum gauge III, wherein the vacuum gauge I is connected to the treatment system, the vacuum gauge II is connected to the vacuum system II, and the vacuum gauge III is connected to the vacuum system I.

14. The halogen element determination device according to claim 11, further comprising a calibration system, wherein the calibration system is simultaneously connected to the extraction system and the treatment system, and the calibration system comprises a standard air tank and a small-volume dispensing tube.

15. The halogen element determination device according to claim 11, wherein the suction pump comprises a titanium sublimation pump, a GP50 suction pump and a NP10 suction pump, and different suction pumps are connected to a main pipeline of the treatment system by different valves.

16. A halogen element determination device, wherein the halogen element determination method according to claim 3 is applied, comprising an extraction system, a treatment system, a vacuum system, and an analysis system; the extraction system comprises a laser device and a sample tray; the laser device is configured to heat a sample placed on the sample tray to extract target gases; the treatment system comprises a suction pump and a cold trap II, the suction pump is configured to adsorb active gases in the target gases, and the cold trap II is configured to enrich and separate purified gases Ar, Kr and Xe according to different condensation temperatures and to enable the gases Ar, Kr and Xe after enrichment and separation to enter the analysis system in turn; the analysis system employs a noble gas mass spectrometer; and the vacuum system is configured to vacuumize the extraction system, the treatment system and the analysis system.

17. The halogen element determination device according to claim 16, wherein the vacuum system comprises a vacuum system I, and a vacuum system II; and the vacuum system I is connected to the extraction system, and the vacuum system II is connected to the treatment system.

18. The halogen element determination device according to claim 17, further comprising a vacuum gauge I, a vacuum gauge II and a vacuum gauge III, wherein the vacuum gauge I is connected to the treatment system, the vacuum gauge II is connected to the vacuum system II, and the vacuum gauge III is connected to the vacuum system I.

19. The halogen element determination device according to claim 16, further comprising a calibration system, wherein the calibration system is simultaneously connected to the extraction system and the treatment system, and the calibration system comprises a standard air tank and a small-volume dispensing tube.

20. The halogen element determination device according to claim 16, wherein the suction pump comprises a titanium sublimation pump, a GP50 suction pump and a NP10 suction pump, and different suction pumps are connected to a main pipeline of the treatment system by different valves.
